(19) United States
(12) Patent Application Publication
(10) Pub. No.: US 2011/0171417 A1
(43) Pub. Date: Jul. 14, 2011

(54) GLASS FILM LAMINATE, GLASS ROLL OF THE LAMINATE, AND METHOD OF PRODUCING GLASS ROLL

(76) Inventors: Takahide NAKAMURA, Otsu-shi (JP); Koichi Mori, Otsu-shi (JP)

(21) Appl. No.: 12/962,938

(22) Filed: Dec. 8, 2010

(30) Foreign Application Priority Data
Dec. 11, 2009 (JP) 2009-282276

(51) Int. Cl. B32B 7/04; B32B 17/00; B32B 7/02; B29C 65/52

(52) U.S. Cl. 428/76; 156/192

(57) ABSTRACT

A glass film laminate includes a glass film, a supporting sheet fixed on one surface of the glass film so as to protrude from the glass film and having a stretch ratio of 10% or less under a tensile strength of 50 MPa, and a protective sheet peelably laminated on the other surface of the glass film so as to cover edge portions of the glass film.

### TECHNICAL FIELD

The present invention relates to a glass film laminate, wherein a glass film is supported by a supporting sheet, a glass roll of the glass film laminate, and a method of producing the glass roll. The glass film is used for a glass substrate for flat panel displays such as a liquid crystal display and an OLED display, devices such as a solar cell, and a cover glass for an OLED lighting device, and the like.

### BACKGROUND ART

In recent years, from the viewpoint of space saving, in place of a CRT type display conventionally and widely used, there have been widely used, flat panel displays such as a liquid crystal display, a plasma display, an OLED display, and a field emission display. Further reduction in thickness is demanded for those flat panel displays. In particular, it is required that the OLED display be easily carried by being folded or wound and be usable not only on a flat surface but also on a curved surface. Further, it is not just displays that are required to be usable not only on a flat surface but also on a curved surface. For example, if a solar cell or an OLED lighting device can be formed on a surface of an object having a curved surface, such as a surface of an automobile body, or a roof, a pillar, or an outer wall of a building, the applications of the solar cell or OLED lighting device may expand. Therefore Substrates and cover glasses used for those devices are required to be a thinner plate and to have high flexibility.

A light-emitting member used for an OLED display deterioratios in quality through the contact of gases such as oxygen. Thus, a substrate used for the OLED display is required to have high gas-barrier property, and hence the use of a glass substrate for the substrate is expected. However, glass used for a substrate is weak in tensile stress unlike a resin film, and hence is low in flexibility. Thus, concentration of a tensile stress on a surface of a glass substrate by bending the glass substrate leads to the breakage of the glass substrate. In order to impart flexibility to the glass substrate, the glass substrate is required to achieve an ultrathin sheet. Thus, a glass film having a thickness of 200 μm or less has been proposed as described in Patent Document 1 below.

By the way, a glass substrate used for electronic devices such as a flat panel display and a solar cell is subjected to various treatments associated with electronic device production, such as a treatment for providing a film such as a transparent conductive film and a washing treatment. However, when the above-mentioned ultrathin glass film is used for those electronic devices, the glass film breaks easily due to even some stress change since glass is a brittle material. Thus, there is a problem in that the handling of the glass film is very difficult, when the above-mentioned various treatments associated with electronic device production are carried out.

Therefore, in order to enhance a handling easiness of a glass film, a laminate of a glass sheet and a resin layer has been proposed as described in Patent Document 2. Patent Document 2 describes a laminate obtained by providing an adhesion layer made of, for example, an adhesive on the resin layer and then laminating a glass film on the resin layer. In such laminate, the glass film is supported by the resin film being a tough material, and hence the handling of the glass film laminate becomes easier compared to a case of the glass film alone when the above-mentioned various treatments associated with production are carried out.

However, even if the above-mentioned glass film laminate is used, there remains a problem in that, when the glass film laminate is handled, cracks occur from edge portions of the glass film, resulting in breaking, chipping, and the like. That is, when the glass film is formed, unnecessary portions for the glass film are cut and eliminated, and hence the edge portions of the glass film have fine flaws produced at the time when the unnecessary portions are cut and eliminated. Thus, if a stress is concentrated on the edge portions of the glass film when the glass film is handled, breaking, chipping, and the like which originate from the fine flaws are produced. Thus, breaking, chipping, and the like cannot be prevented by merely laminating a resin layer on one surface of a glass film as described in Patent Document 2.

### CITATION LIST

### Patent Document

Patent Document 1: JP 2008-133174 A
Patent Document 2: JP 2001-97733 A

### SUMMARY OF INVENTION

### Technical Problem

The present invention has been made to solve the above-mentioned problems with prior arts. It is an object of the present invention to provide a glass film laminate, a glass roll of the glass film laminate, and a method of producing the glass roll, wherein the glass film is capable of being effectively prevented from breaking, chipping, and the like occurring from edge portions of the glass film, and capable of being further enhanced the handling easiness, when the glass film is subjected to treatments associated with production.

### Solution to Problem

The present invention provides a glass film laminate comprising a glass film, a supporting sheet fixed on one surface of the glass film so as to protrude from the glass film and having a stretch ratio of 10% or less under a tensile strength of 50 MPa, and a protective sheet peelably laminated on the other surface of the glass film so as to cover edge portions of the glass film.

In the glass film laminate of the present invention, the glass film preferably has a thickness of 300 μm or less.

In the glass film laminate of the present invention, the supporting sheet preferably has a pressure-sensitive adhesive force of 1 to 25 N/25 mm.

In the glass film laminate of the present invention, the supporting sheet preferably has a thickness of 3 to 250 μm.

In the glass film laminate of the present invention, the protective sheet preferably has a thickness of 3 to 250 μm.

In the glass film laminate of the present invention, the protective sheet preferably covers pressure-sensitive adhesive portions of the supporting sheet.

In the glass film laminate of the present invention, the protective sheet preferably has substantially the same size as the supporting sheet.

Further, the present invention provides a glass roll, which is produced by winding the above-mentioned glass film laminate.

Further, the present invention provides a method of producing a glass roll, comprising the steps of laminating a pressure-sensitive adhesive supporting sheet having a stretch ratio of 10% or less under a tensile strength of 50 MPa on one surface of a glass film so as to protrude from the glass film, peelably laminating a protective sheet on the other surface of the glass film so as to cover edge portions of the glass film and pressure-sensitive adhesive portions of the supporting sheet, thereby to produce a glass film laminate, and winding the glass film laminate to produce a glass roll.

### Advantageous Effects of Invention

The glass film laminate according to the present invention comprises the glass film, the supporting sheet fixed on one surface of the glass film so as to protrude from the glass film and having a stretch ratio of 10% or less under a tensile strength of 50 MPa, and the protective sheet peelably laminated on the other surface of the glass film so as to cover the edge portions of the glass film. As a result, the edge portions of the glass film are protected by sandwiching the edge portions with the supporting sheet and the protective sheet, and hence it is possible to effectively prevent breaking, chipping, and the like occurring from the edge portions of the glass film. Consequently, it becomes possible to prevent stress from concentrating in the edge portions of the glass film, resulting in the effective prevention of the occurrence, in the glass film, of breaking, chipping, and the like which originate from fine flaws or the like remaining in the end surface of the glass film. Thus, the handling easiness of the glass film can be enhanced. Besides, the supporting sheet has a stretch ratio of 10% or less under a tensile strength of 50 MPa, and hence, when the protective sheet is peeled, the supporting sheet resists plastic deformation in the stretching direction, and even in the state in which the supporting sheet is fixed, it is possible to prevent the entire deformation of the glass film laminate which is caused in synchronization with the wave-shaped deformation of the supporting sheet attributed to the stretching of the supporting sheet.

When the glass film has a thickness of 300 μm or less, the glass film has a sufficient flexibility. The glass film has a thickness of preferably 200 μm or less, more preferably 100 μm or less, still more preferably 50 μm or less. However, when the glass film is too thin, problems such as breaking and chipping are likely to occur, and hence the thickness is preferably set to 1 μm or more.

When the supporting sheet has a pressure-sensitive adhesive force of 1 to 25 N/25 mm, the supporting sheet and the glass film can be firmly fixed to each other and the protective film can be easily peeled, and hence, when the protective film is peeled, it is possible to effectively prevent plastic deformation in the stretch direction from occurring in the supporting sheet.

When the supporting sheet has a thickness of 3 to 250 μm, the supporting sheet can steadily support the glass film.

When the protective sheet has a thickness of 3 to 250 μm, the protective sheet can properly protect the glass film and the supporting sheet.

When the protective sheet covers the pressure-sensitive adhesive portions of the supporting sheet, it is possible to prevent dust or the like from attaching to the pressure-sensitive adhesive portions of the supporting sheet and to prevent the supporting sheet from adhering to other members or the like when the glass film is handled.

When the protective sheet has substantially the same size as the supporting sheet, it becomes possible for the protective sheet to fully cover both one surface of the glass film and the pressure-sensitive adhesive surface of the supporting sheet. Thus, it is possible to prevent dust or the like from attaching to the pressure-sensitive adhesive portions of the supporting sheet and to prevent the supporting sheet from adhering to other members or the like when the glass film is handled. As a result, the glass film can be handled more easily, and not only the edge portions but also the entire surface of the glass film can be protected.

The glass roll of the present invention is produced by winding the above-mentioned glass film laminate. Thus, even in the case where a glass roll, in which stress is likely to be concentrated particularly in the edge portions of a glass film, is produced, it is possible to wind the glass film laminate well while preventing breaking, chipping, and the like from occurring in the glass film. Further, the pressure-sensitive adhesive surface of the supporting sheet is covered with the protective sheet, and hence, when the glass film laminate is wound to produce the glass roll, it is possible to prevent a supporting sheet in an inner layer and a supporting sheet in an outer layer from overlapping to be adhered to each other, resulting in the elimination of a cause for deflection during the winding. As a result, when the glass film laminate is wound to produce the glass roll, it becomes possible to absorb deflection, making easy winding of the glass film laminate possible, and even if displacement occurs between an inner layer and an outer layer, the displacement can be easily corrected. Moreover, when the protective sheet is peeled, the supporting sheet resists plastic deformation in the stretch direction, and hence, even in the state in which the supporting sheet is fixed, it is possible to prevent the entire deformation of the glass film laminate.

According to the method of producing a glass roll of the present invention, a pressure-sensitive adhesive supporting sheet having a stretch ratio of 10% or less under a tensile strength of 50 MPa is laminated on one surface of a glass film so as to protrude from the glass film, a protective sheet is peelably laminated on the other surface of the glass film so as to cover edge portions of the glass film and pressure-sensitive adhesive portions of the supporting sheet, thereby to produce a glass film laminate, and then the glass film laminate is wound to produce a glass roll. Thus, it becomes possible to produce a glass roll in which a glass film has no breaking and chipping and no displacement between each inner layer and outer layer occurs during winding. Moreover, it becomes possible to produce a glass roll in which the plastic deformation of the supporting sheet in the stretch direction is prevented when the protective sheet is peeled at the time of use, and no warpage, no wave-shaped deformation, and no deflection exist even in the state in which the supporting sheet is fixed.

### BRIEF DESCRIPTION OF DRAWINGS

FIG. 1(a) is a plan view of a first embodiment of a glass film laminate according to the present invention.

FIG. 1(b) is a cross-sectional view taken along the line A-A of FIG. 1(a).

FIG. 2 is an explanatory diagram of an apparatus for producing a glass film.

FIG. 3 is a view showing that a supporting sheet and a protective sheet are each provided with a peeling starting portion.

FIG. 4(a) is a plan view of a second embodiment of a glass film laminate according to the present invention.

FIG. 4(b) is a cross-sectional view taken along the line B-B of FIG. 4(a).

FIG. 5 is a view of a glass roll according to the present invention.

### DESCRIPTION OF EMBODIMENTS

Hereinafter, preferred embodiments of a glass film laminate and a glass roll of the glass film laminate according to the present invention are described with reference to the drawings.

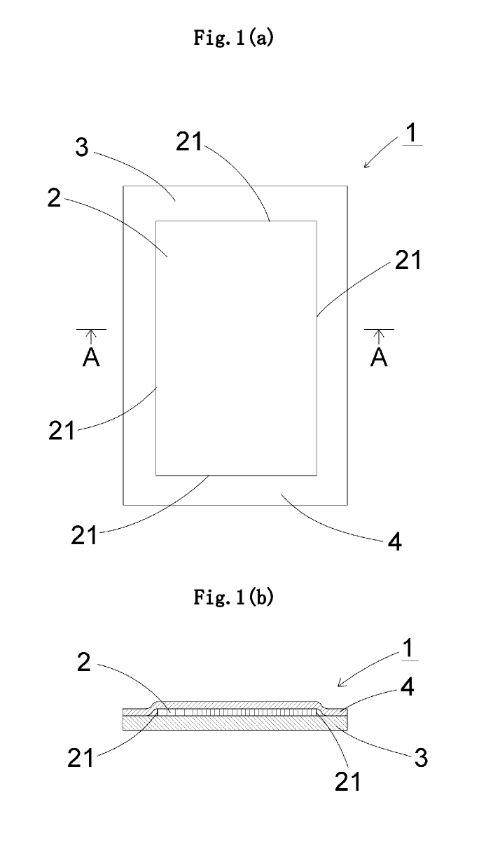

A glass film laminate (1) according to the present invention includes a glass film (2), a supporting sheet (3), and protective sheet (4) as shown in FIG. 1 {FIG. 1(a) and FIG. 1 (b)}.

For the glass film (2), silicate glass is used, silica glass or borosilicate glass is preferably used, or alkali-free borosilicate glass is most preferably used. If the glass film (2) contains an alkali component, cation replacement occurs on a surface of the glass film, leading to occurrence of a so-called too-abundant soda phenomenon and resulting in a coarse structure. In this case, if the glass film (2) is continuously used in a bent state, the glass film (2) may break at a portion whose structure has become course due to aging degradation. Note that the alkali-free borosilicate glass is glass substantially free of an alkali component, and specifically, glass that contains the alkali component at a weight ratio of 1,000 ppm or less. The content of the alkali component in the present invention is preferably 500 ppm or less, more preferably 300 ppm or less.

The glass film (2) has a thickness of preferably 300 μm or less, more preferably 1 μm to 200 μm, more preferably 1 to 100 μm, most preferably 5 μm to 50 μm. With this, a thickness of the glass film (2) may be made thinner to impart an appropriate flexibility to the glass film (2). Further, in this case, treatments associated with production can be easily carried out even in an ultrathin glass film, which tends to cause problems such as breaking and chipping. Moreover, even for the ultrathin glass film, which is more susceptible to the plastic deformation of a supporting sheet protruding from the ultrathin glass film, it is possible to prevent the entire deformation of the glass film laminate. If the thickness is less than 1 μm, the glass film (2) tends to have insufficient strength. As a result, when the protective sheet (4) is peeled from the glass film laminate (1) to be incorporated into a device, the glass film (2) becomes liable to cause a breakage.

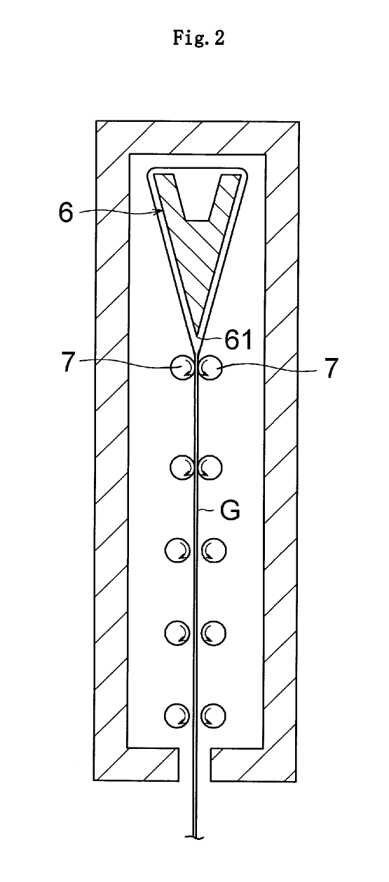

The glass film (2) to be used in the present invention is preferably formed by an overflow down-draw method as shown in FIG. 2. The overflow down-draw method is a forming method in which both surfaces of a glass sheet are not brought into contact with a forming member during a formation process, and hence flaws are hardly caused on the both surfaces (translucent surfaces) of the obtained glass plate, and high surface-quality may be obtained for the glass sheet without polishing work.

A glass ribbon (G) immediately after being flown down from a lower end portion (61) of a forming body (6) having a wedge shape in its cross-section is drawn downwardly with a cooling roller (7) with its shrinkage in a width direction being restricted, resulting in a thin ribbon having a predetermined thickness. Subsequently, the glass ribbon (G) having the predetermined thickness is annealed in an annealer to remove heat strain in the glass ribbon (G), followed by cutting of the glass ribbon (G) into pieces having a predetermined size. Thus, the glass film (2) is formed.

The supporting sheet (3) is, as shown in FIG. 1, fixed so as to protrude from the glass film (2). The protruding length of the supporting sheet (3) is preferably 0.1 cm to 50 cm, more preferably 0.5 to 10 cm, from edge portions (21) of the glass film (2). When the protruding length is less than 0.1 cm, the edge portions (21) may be apt to be protected insufficiently. On the other hand, when the protruding length is more than 50 cm, handling the glass film laminate (1) may become difficult.

The supporting sheet (3) has a stretch ratio of 10% or less under a tensile strength of 50 MPa. Thus, even in the case where the protective sheet (4) is peeled with a tensile force of 50 MPa, the supporting sheet (3) protruding from the glass film (2) resists plastic deformation in the stretch direction. As a result, it is possible to prevent the entire deformation of the glass film laminate (1) even in the state in which the supporting sheet (3) is fixed. If the supporting sheet (3) has a stretch ratio of more than 10%, the deformation amount of the supporting sheet (3) becomes excessive when the protective sheet (4) is peeled, resulting in the occurrence of warpage, wave-shaped deformation, and deflection in the glass film laminate (1). The supporting sheet (3) has a stretch ratio of more preferably 8% or less, most preferably 5% or less, under a tensile strength of 50 MPa.

It is preferable to use, as the supporting sheet (3) having a stretch ratio of 10% or less under a tensile strength of 50 MPa, a sheet made of stretched polypropylene, cellulose triacetate, polyethylene terephthalate, a polyester, a polyolefin, or the like. More preferably used is a polyethylene terephthalate film or a stretched polypropylene film. On the other hand, a sheet made of cast polypropylene, high pressure polyethylene, soft vinyl chloride, or the like cannot be used because each has a stretch ratio of more than 10% under a tensile strength of 50 MPa.

The supporting sheet (3) has a thickness of preferably 3 to 250 μm, more preferably 10 to 100 μm. This enables the supporting sheet (3) to support the glass film (2) steadily. If the supporting sheet (3) has a thickness of less than 3 μm, the thickness of the supporting sheet (3) is too small, and if the supporting sheet (3) has a thickness of more than 250 μm, the glass film laminate (1) as a whole is too thick. Both the cases may lead to an increase in difficulty in handling the glass film laminate (1).

The supporting sheet (3) has a pressure-sensitive adhesive force of preferably 1 to 25 N/25 mm, more preferably 10 to 25 N/25 mm, most preferably 15 to 25 N/25 mm. With this, the supporting sheet (3) can be peeled with a tensile force of 50 MPa, the supporting sheet (3) and the glass film (2) can be fixed firmly while plastic deformation in the stretch direction is effectively prevented from occurring in the supporting sheet (3), and easily peeling the protective sheet (4) becomes possible. If the supporting sheet (3) has a pressure-sensitive adhesive force of less than 1 N/25 mm, the supporting sheet (3) may be apt to have an insufficient pressure-sensitive adhesive force. If the supporting sheet (3) has a pressure-sensitive adhesive force of more than 25N/25 mm, peeling the protective sheet (4) may become difficult. Particularly in the case where the supporting sheet (3) has a pressure-sensitive adhesive force of 15 to 25N/25 mm, fixing property between the supporting sheet (3) and the glass film (2) and peeling property between the supporting sheet (3) and the protective sheet (4) achieve a good balance, which is most preferred. Further, pressure-sensitive adhesive property is usually provided to the entire surface of the supporting sheet (3), but it is not necessary to provide pressure-sensitive adhesive property to the entire surface of the supporting sheet (3). Pressure-sensitive adhesive property may only be provided to a portion at least slightly larger than the surface portion adhering to the glass film (2).

The protective sheet (4) is peelably laminated on the other surface, with which the supporting sheet (3) is not brought into contact, of the glass film (2) so as to cover the edge portions (21) of the glass film (2). Thus, the edge portions (21) of the glass film (2) can be protected by sandwiching the edge portions (21) with the supporting sheet (3) and the protective sheet (4). Accordingly, it becomes possible to prevent stress from being concentrated in the edge portions (21) of the glass film (2), and breaking, chipping, and the like derived from fine flaws or the like remaining in the end surface of the glass film (2) can be effectively prevented from occurring in the glass film (2). Thus, the handling easiness of the glass film laminate (1) can be enhanced.

A resin having flexibility is preferably used for the protective sheet (4) for enhancing handling easiness. It is possible to use, for example, polyethylene, polyvinyl chloride, polyethylene terephthalate, polyvinylidene chloride, polypropylene, polyvinyl alcohol, a polyester, polycarbonate, polystyrene, polyacrylonitrile, an ethylene-vinyl acetate copolymer, an ethylene-vinyl alcohol copolymer, an ethylene-methacrylate copolymer, Nylon (registered trademark), cellophane, or a silicone resin. Of those, polyethylene terephthalate or polyethylene is preferably used. Alternatively, an independent air bubble type foamed resin may be used. That is, the use of a foamed resin for the protective sheet (4) imparts high flexibility to the protective sheet (4). Moreover, the use of the independent air bubble type foamed resin can prevent dust in the atmosphere from attaching to the glass film (2) through the protective sheet (4). The color of the protective sheet (4) is not particularly limited because the sheet is peeled and removed eventually. The protective sheet (4) may not be subjected to coloring, that is, may be colorless. Alternatively, the protective sheet (4) may have a color such as white, black, blue, green, or yellow, in order to make it possible to distinguish whether the protective sheet (4) has been peeled from the glass film laminate (1). In this case, the translucency of the protective sheet (4) is not particularly limited, either. The protective sheet (4) may be, for example, transparent, semi-transparent, or opaque.

The protective sheet (4) has a thickness of preferably 3 to 250 μm, more preferably 10 to 100 μm. This enables the appropriate protection of the glass film (2) and the supporting sheet (3). If the protective sheet (4) has a thickness of less than 3 μm, the thickness of the protective sheet (4) is too small, and if the protective sheet (4) has a thickness of more than 250 μm, the glass film laminate (1) as a whole is too thick. Both the cases may lead to an increase in difficulty in appropriately protecting the glass film (2).

The protective sheet (4) preferably covers the pressure-sensitive adhesive portions of the supporting sheet (3). This enables prevention of dust or the like from attaching to the pressure-sensitive adhesive portions of the supporting sheet (3) and prevention of the supporting sheet (3) from adhering to other members or the like in handling the glass film (2). When pressure-sensitive adhesive property is provided on the entire surface of the supporting sheet (3), the protective sheet (4) preferably entirely covers the surface portion of the supporting sheet (3) protruding from the glass film (2). On the other hand, when pressure-sensitive adhesive property is provided on a partial surface of the supporting sheet (3), the protective sheet (4) preferably covers at least the portion on which the pressure-sensitive adhesive property is provided.

The protective sheet (4) preferably has, as shown in FIG. 1, substantially the same size as the supporting sheet (3). This enables the protective sheet (4) to completely cover the surface of the glass film (2) and the surface of the supporting sheet (3). Accordingly, it is possible to prevent the attachment of dust or the like to the pressure-sensitive adhesive portions of the supporting sheet (3), which is attributed to the exposure of the pressure-sensitive adhesive portions, and to prevent the supporting sheet (3) from adhering to other members in handling the glass film (2), good handling of the glass film (2) becomes possible, and the entire surface of the glass film (2) can be protected.

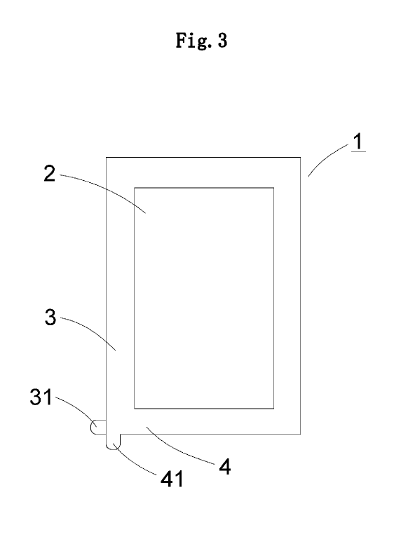

FIG. 3 is a view showing that a supporting sheet and a protective sheet are each provided with a peeling starting portion.

The supporting sheet (3) and the protective sheet (4) are provided with peeling starting portions (31) and (41) closely to each other, respectively, so that the peeling starting portions (31) and (41) each protrude from the glass film laminate (1) by about 1 cm at most. As a result, the protective sheet (4) can be easily peeled from the supporting sheet (3) by separately grabbing each of the peeling starting portion (31) provided on the supporting sheet (3) and the peeling starting portion (41) provided on the protective sheet (4) and then separating the supporting sheet (3) and the protective sheet (4) from each other.

In the glass film laminate (1) according to the present invention, the glass film (2) and the supporting sheet (3) are fixed to each other. Thus, when the glass film laminate (1) is used as a substrate for electronic devices and the like, after the protective sheet (4) is peeled and removed, the glass film (2) and the supporting sheet (3) are not detached, that is, the glass film laminate (1) is used in the state in which the glass film (2) and the supporting sheet (3) are kept fixed to each other. Alternatively, if required, the portions of the supporting sheet (3) protruding from the glass film (2) may be cut and removed.

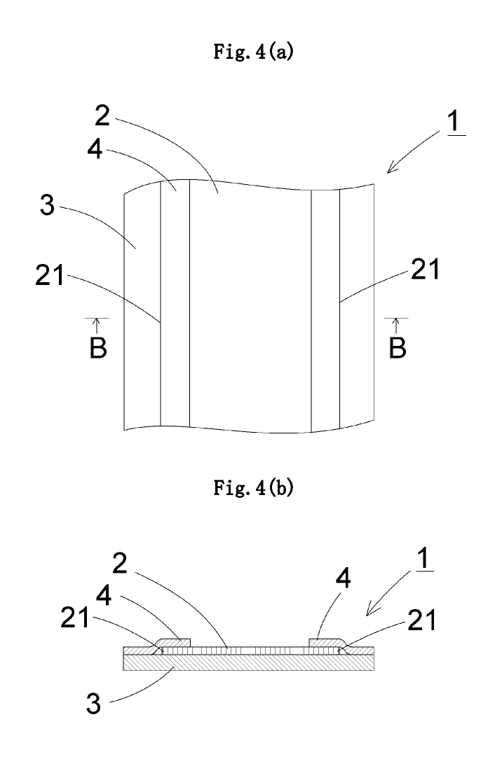

FIG. 4 {FIGS. 4(a) and 4(b)} are views of a second embodiment of the glass film laminate according to the present invention. FIG. 4(a) is a plan view and FIG. 4 (b) is a cross-sectional view taken along the line B-B of FIG. 4(a).

In the glass film laminate (1) according to the second embodiment, as shown in FIG. 4, protective sheet (4) covers only the pressure-sensitive adhesive surface of the supporting sheet (3) and the vicinity of the edge portions (21) of the glass film (2), but do not cover the effective surface of the glass film (2). Thus, the protective sheet (4) protects the edge portions (21) of the glass film (2), so that the glass film (2) is effectively prevent from breaking, chipping, and the like, resulting in the enhancement of the handling easiness of the glass film (2). Also, treatment associated with production such as film formation and patterning can be satisfactorily carried out to the effective surface of the glass film (2).

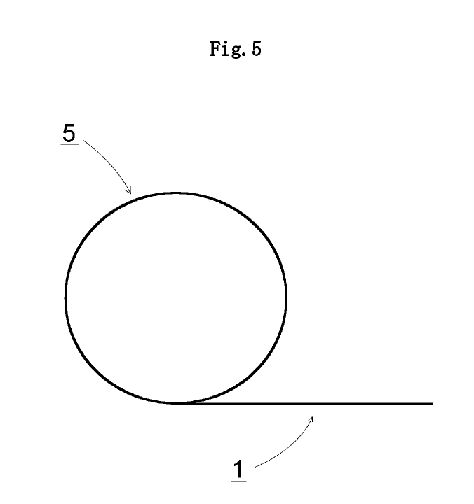

FIG. 5 is a view of a glass roll according to the present invention.

A glass roll (5) according to the present invention is formed by winding the above-mentioned glass film laminate (1). Thus, even when the glass roll (5), in which stress is apt to be concentrated particularly in the edge portions (21) of the glass film (2), is produced, the glass film laminate (1) can be wound while the occurrence of breaking, chipping, and the like in the glass film (2) are being prevented.

The protective sheet (4) covers the pressure-sensitive adhesive surface of the supporting sheet (3), and hence, when the glass roll (5) is produced by winding the glass film laminate (1), it is possible to prevent a phenomenon in which, in multiple layers formed by winding the glass film laminate (1) doubly, triply, etc., portions of the supporting sheet (3) are overlapped and adhere to each other. As a result, a cause for deflection in winding can be eliminated. Thus, when the glass film laminate (1) is wound, the winding can be performed while deflection of the glass film laminate (1) is absorbed, which enables to wind the glass film laminate (1) while preventing displacement of layers of the glass roll (1), or while correcting displacement of layers of the glass roll (1), if occurred. Thus the glass film laminate (1) is easy to handle and wind, so that the glass film laminate (1) can be easily applied to a roll-to-roll process when treatment associated with production is carried out. Further, it becomes possible to produce the glass roll (5), in which the plastic deformation of the supporting sheet (3) in the stretch direction is prevented when the protective sheet (4) is peeled, and no warpage, no wave-shaped deformation, and no deflection exist even in the state in which the supporting sheet (3) is fixed.

### EXAMPLES

Hereinafter, the glass film laminate of the present invention is described in detail based on examples, but the present invention is not limited to those examples.

### Examples

Alkali-free borosilicate glass manufactured by Nippon Electric Glass Co., Ltd. (product name: OA-10G, thermal expansion coefficient at 30 to 380° C.: 38×10⁻⁷/° C.) was used and formed into a shape by an overflow down-draw method. After that, the resultant glass was properly annealed, cut, and processed, thereby producing a glass film having a length of 5000 mm, a width of 150 mm, and a thickness of 50 μm. Used as a supporting sheet was a stretched polypropylene film having a length of 5020 mm, a width of 150 mm, and a thickness of 50 μm (manufactured by FUTAMURA CHEMICAL CO., LTD.). Used as a protective sheet was a polyethylene terephthalate film having a length of 5020 mm, a width of 170 mm, and a thickness of 50 μm (manufactured by Toray Industries Inc.). The glass film was fixed on each of the supporting sheets having respective pressure-sensitive adhesive forces listed in Table 1. In addition, the protective sheet was laminated on the resultant product so as to entirely cover the surface of the glass film, thereby producing a glass film laminate.

### Comparative Example

A glass film laminate was produced in the same manner as in the examples, except that a cast polypropylene film (manufactured by Teijin DuPont Films Japan Limited) was used as the supporting sheet.

(Peeling Test)

The protective sheet was peeled from each of the glass film laminates of the examples and comparative example. Evaluation was made on the deformation amount of the glass film laminate after the peeling of the protective sheet, and on the fixing property between the supporting sheet and the glass film. The deformation amount of the glass film laminate after the peeling of the protective sheet was evaluated according to the following criteria. A glass film laminate which did not undergo deformation after the peeling of the protective sheet was represented by “⊚)”. A glass film laminate which underwent slight deformation at a negligible level after the peeling of the protective sheet was represented by “∘”. A glass film laminate which underwent remarkable deformation in a wave shape after the peeling of the protective sheet was represented by “x”. The fixing property between the supporting sheet and the glass film was evaluated according to the following criteria. A glass film laminate in which no peeling between the supporting sheet and the glass film occurred was represented by “⊚”. A glass film laminate in which partial peeling between the supporting sheet and the glass film was slightly observed but any practical problem was not included was represented by “∘”. A glass film laminate in which the glass film was not fixed to the supporting film and was thus peeled was represented by “x”. Table 1 shows the results.

TABLE 1

| | Example | Example | Example | Example | Example | Comparative |
|---|---|---|---|---|---|---|
| | 1 | 2 | 3 | 4 | 5 | Example |
| Stretch ratio | 10 | 10 | 10 | 8 | 5 | 160 |
| (%) of | | | | | | |
| supporting sheet | | | | | | |
| under 50 MPa (%) | | | | | | |
| Pressure-sensi- | 5 | 10 | 16 | 5 | 5 | 5 |
| tive adhesive | | | | | | |
| ratio of | | | | | | |
| supporting sheet | | | | | | |
| (N/25 mm) | | | | | | |
| Evaluation on | ◯ | ◯ | ◯ | ⊚ | ⊚ | X |
| deformation of | | | | | | |
| laminate | | | | | | |
| Evaluation on | ◯ | ⊚ | ⊚ | ◯ | ◯ | ◯ |
| fixing property | | | | | | |
| between | | | | | | |
| supporting sheet | | | | | | |
| and glass film | | | | | | |
| after peeling | | | | | | |

As shown in Table 1, with respect to each of the glass film laminates of Examples 1 to 5 including the supporting sheet having a stretch ratio of 10% or less under 50 MPa, it is found that the deformation of the laminate is prevented because the supporting sheet protruding from the glass film does not stretch even when the protective sheet is peeled. On the other hand, with respect to the glass film laminate of the comparative example including the supporting sheet having a stretch ratio of more than 10% under 50 MPa, it is found that a wave-shaped deformation occurred in the laminate because the supporting sheet was stretched by a tensile force produced when the protective sheet was peeled from the supporting sheet.

### INDUSTRIAL APPLICABILITY

The present invention can be suitably used as a glass substrate for devices such as flat panel displays including a liquid crystal display and an OLED display and a solar cell and as a cover glass for an OLED lighting device.

### REFERENCE SIGNS LIST

1 glass film laminate
2 glass film
21 edge portion
3 supporting sheet
4 protective sheet
5 glass roll

1. A glass film laminate, comprising:
a glass film;
a supporting sheet fixed on one surface of the glass film so as to protrude from the glass film and having a stretch ratio of 10% or less under a tensile strength of 50 MPa; and
a protective sheet peelably laminated on the other surface of the glass film so as to cover edge portions of the glass film.

2. The glass film laminate according to claim 1, wherein the glass film has a thickness of 300 μm or less.

3. The glass film laminate according to claim 1, wherein the supporting sheet has a pressure-sensitive adhesive force of 1 to 25 N/25 mm.

4. The glass film laminate according to claim 1, wherein the supporting sheet has a thickness of 3 to 250 μm.

5. The glass film laminate according to claim 1, wherein the protective sheet has a thickness of 3 to 250 μm.

6. The glass film laminate according to claim 1, wherein the protective sheet covers pressure-sensitive adhesive portions of the supporting sheet.

7. The glass film laminate according to claim 1, wherein the protective sheet has substantially the same size as the supporting sheet.

8. A glass roll, which is produced by winding the glass film laminate according to claim 6.

9. A method of producing a glass roll, comprising the steps of:
laminating a pressure-sensitive adhesive supporting sheet having a stretch ratio of 10% or less under a tensile strength of 50 MPa on one surface of a glass film so as to protrude from the glass film;
peelably laminating a protective sheet on the other surface of the glass film so as to cover edge portions of the glass film and pressure-sensitive adhesive portions of the supporting sheet, thereby to produce a glass film laminate; and
winding the glass film laminate to produce a glass roll.

10. A glass roll, which is produced by winding the glass film laminate according to claim 7.
